(19) United States
(12) Patent Application Publication
(10) Pub. No.: US 2007/0210667 A1
(43) Pub. Date: Sep. 13, 2007

(54) SQUIRREL-CAGE ROTOR

(76) Inventor: Hartmut Vogel, Erlangen (DE)

Correspondence Address: HENRY M FEIEREISEN, LLC, 350 FIFTH AVENUE, SUITE 4714, NEW YORK, NY, 10118, US

(21) Appl. No.: 10/595,238

(22) PCT Filed: Sep. 27, 2004
(86) PCT No.: PCT/EP04/10815

§ 371 Date: Jan. 23, 2007

(30) Foreign Application Priority Data
Sep. 29, 2003 (DE) 10345637.6

(51) Int. Cl. H02K 17/00

(52) U.S. Cl. 310/211

(57) ABSTRACT

A squirrel-cage rotor (1) includes squirrel-cage rotor conductors (3) and a carrier (5) for the squirrel-cage rotor conductors (3). The carrier (5) is provided with axial slots (9) in which the squirrel-cage rotor conductors (3) are accommodated. An axial slot (9) includes at least one closed slot portion (11) and an open slot portion (13), with the open slot portion (13) located between the closed slot portion (11) and a cage ring (15). In a method for producing a squirrel-cage rotor (1) having a carrier (5) for squirrel-cage rotor conductors (3), with the carrier (5) having closed slots (9), the squirrel-cage rotor conductors (3) are cast into the slots or are inserted therein as bars, whereupon carrier material is removed in the area of the end surfaces (29) of the carrier (5) in such a way that an open slot portion (13) is formed.

### BACKGROUND OF THE INVENTION

The invention relates to a squirrel-cage rotor and to a method of making a squirrel-cage rotor. Squirrel-cage rotors can be used in motors as well as generators. Squirrel-cage rotors find hereby application in particular in asynchronous machines.

Squirrel-cage rotors have squirrel-cage rotor conductors and cage rings, with the cage rings shorting ends of the squirrel-cage rotor conductors. Squirrel-cage rotor conductors and terminal cage rings establish a cage, the short-circuit rotor cage. A cage winding is provided by means of the electric connection between squirrel-cage rotor conductor and cage ring.

The squirrel-cage rotor conductors are implemented for example by metallic rotor bars extending in slots. The slots are preferably axial slots having an axial preferential direction, with an axial slot extending either parallel to the rotation axis of the squirrel-cage rotor or being slanted in a parallel axial preferential direction. The rotor bars are shorted for example through soldering or welding with a cage ring.

Squirrel-cage windings, i.e. squirrel-cage rotor conductors and/or cage rotor rings can also be made by a casting process. Cast squirrel-cage windings made, for example, of aluminum, copper or another highly conductive metal or alloys have a cage ring which oftentimes rests directly on the laminated core, i.e. on the carrier of the squirrel-cage rotor conductors. The cage ring is connected there with the rotor bars. The connection is established for example already by casting the squirrel-cage winding.

The rotor bars, i.e. squirrel-cage rotor conductors, are oftentimes fully enclosed by magnetic rotor material for casting reasons. An example of a magnetic rotor material is magnetic sheet or sheet steel. Advantageously, no fusion takes place between the magnetic rotor material, used in particular as carrier of the squirrel-cage rotor conductors, and the cage.

In addition to subjecting the components to a centrifugal force, the magnetic material as well as the cage material undergoes a rise in temperature, when the electric machine is operated, whereby under certain operating conditions the cage material as well as the magnetic material heat-up in part to a considerably higher extent. The squirrel-cage rotor is thus exposed during operation to thermal stress.

As a result of the heat expansion of the components of the squirrel-cage rotor conductor, i.e. the component ‘magnetic rotor material’ and the component ‘cage’, with different coefficients of thermal expansion, and as a result of the fact that the cage ring is able to freely expand radially while the rotor bars are prevented from moving radially in view of the at least partial enclosure with magnetic material, significant mechanical stress is experienced in the transition cage ring to rotor bar.

Because there is no distance or only too little distance between cage ring and surrounded rotor bars, the connection between cage ring and enveloped rotor bars is exposed to very significant shearing stress as soon as the casting-based clearance (gap) between rotor bars and magnetic material has been bridged in view of a thermal expansion. As a result of the described problem, the connection rotor bar to cage ring is in danger of encountering a fatigue fracture, depending on the mode of operation of the electric machine. When the rotor bars have a substantially greater length than the carrier of the rotor bars, fatigue fracture can be reduced. There is however the drawback of prolongation of the axial length of the squirrel-cage rotor. This increases the configuration of an electric machine which includes a squirrel-cage rotor.

### SUMMARY OF THE INVENTION

It is an object of the invention to provide an improved squirrel-cage rotor. The improvement relates especially to the temperature behavior of the squirrel-cage rotor. Material stress should be reduced, whereby implementation of especially a compact structure of the squirrel-cage rotor and electric machine which includes the squirrel-cage rotor is demanded.

The squirrel-cage rotor includes squirrel-cage rotor conductors as stated already in the description above. At operation of the electric machine, the squirrel-cage rotor conductors of the squirrel-cage rotor are exposed to shearing stress. This shearing stress is reduced in accordance with the invention.

According to one aspect of the invention, a squirrel-cage rotor includes squirrel-cage rotor conductors and a carrier for the squirrel-cage rotor conductors, with the carrier having axial slots in particular for accommodating the squirrel-cage rotor conductors. The axial slot includes hereby at least one closed slot portion and an open slot portion, with the open slot portion situated between the closed slot portion and a cage ring.

In this way, the shearing stress can be significantly reduced through creation of a flexible squirrel-cage rotor conductor region so that the respective electric machine can be utilized in a thermally higher and dynamically higher manner. The squirrel-cage rotor conductor region is in particular a region of a rotor bar. The flexibility is realized by means of the provided open slot portion.

The open slot portion is open to such an extent that the squirrel-cage rotor conductor, such as, e.g., a bar or several bars, is open entirely on the open side. The open slot portion is completely open, when the squirrel-cage rotor conductor is not held, especially by the carrier, on the open side of the slot.

The closed slot portion is closed to such an extent that the squirrel-cage rotor conductor is held also on the closed side of the slot. The closed slot portion is either a fully closed slot, or a slot which is partially open on one side such that the squirrel-cage rotor conductor is held on the partially opened side of the slot and thus unable to expand in the direction of the opening especially through heating.

Advantageously, the open slot portion has an opening in the radially outer area of the slot. In this way, the rotor bar the squirrel-cage rotor conductor can expand radially to the outside. Also the cage ring, which is mechanically connected to the squirrel-cage rotor conductors, undergoes i.a. a radially outwardly directed expansion during heating. As cage ring as well as squirrel-cage rotor conductor are thus able to jointly expand during heating in a same direction, mechanical stress is at least reduced.

Heretofore, squirrel cages in particular of large electric machines have been configured with squirrel-cage rotors, for example with, e.g. drawn, bars as well as single rings of conductive materials such as copper and aluminum or respective alloys, whereby the rotor bars are normally connected to one another and to the cage rings through welding or soldering. The rotor bars are hereby configured always longer than the laminated rotor core to thereby realize a flexible bar projection by which the afore-described shearing stress in the connection of the bars with the cage ring is transformed into bending stress at significantly lower level in the area of the bar projection.

According to a further embodiment, the open slot portion has an opening in the radially inner region of the slot. As an inwardly directed expansion of a rotor bar is made possible, the need for an opening of the slot radially outwards can be eliminated to thereby establish a good stiffness with respect to centrifugal forces. Advantageously, the open slot portion can also be so configured as to have an open slot portion which is opened to the outside as well as to the inside. This again reduced possible stress.

By means of the particular geometry and a simple after-treatment following casting for windings made through casting, a flexible bar zone is produced at the transition to the cage ring so as to realize there a mechanical stress situation just like in overlong rotor bars. The slots can have a geometry of e.g. wedge-shaped cross section, with the wider part being on the outside. Another embodiment involves the provision of slots with parallel-shaped cross section. The flanks of the slot extend in parallel relationship in such a cross section. A slot base connects to the flanks.

The object is attained irrespective of the casting process; however the problem in conjunction with a die-cast rotor is especially great in view of the hydrostatic and hydrodynamic pressures of the liquid rotor material during casting.

The bar end, e.g. of a cast rotor, can be geometrically designed so as to be radially movable, i.e. flexible, in the area of the open slot portion after removing the radially superposed magnet material.

Advantageously, a bar geometry may change over the rotor length, with the bar end being optimized mechanically and provided optionally with other geometries than the electrically optimized bar shapes in the inner remainder of the rotor.

According to a configuration, the rotor bars, or at least the end of the rotor bar, is geometrically designed such that the bar ends are radially movable to the outside as soon as the magnetic material radially above the bars has been removed, e.g. through mechanical turning, from the rotor end to the desired length of the flexible region. Little amount of bar material may also be removed in correspondence with the selected geometry.

As the magnetic rotor material is normally configured from punched sheet metal blanks or sheet metal blanks made through laser treatment, the mechanical stress situation—flexure in the bars through thermo-mechanical stress during operation of the electric machine—can be additionally so optimized in the bars, i.e. reduced that the rotor ends can be implemented with metal sheets of different slot geometries, i.e. bar geometry, than in the central rotor region. It is hereby advantageous to configure this region significantly longer than the region being worked on to prevent additional notch stress in the flexible zone.

The carrier of for example rotor bars has advantageously a soft-magnetic material. The carrier is hereby laminated or can be made from a component material with iron particles or sheet metal particles.

The stress situation at the ends of the rotor bars can be calculated by a computation method such as the FEM-process. In the event the cage ring directly connects to the carrier, the computation method enables calculation of stress upon the squirrel-cage rotor conductors.

The squirrel-cage rotor according to the invention is applicable in various electric machines. Examples include asynchronous machines as well as electric machines which include a squirrel-cage rotor winding for start-up.

The object with respect to improvement of a squirrel-cage rotor is also attained by means of a method of making a squirrel-cage rotor. The squirrel-cage rotor includes a carrier for squirrel-cage rotor conductors, with the carrier having closed slots. The squirrel-cage rotor conductors are cast into the slots or placed as bars into the slots whereupon carrier material is then removed in the area of the end surfaces of the carrier in order to form an open slot portion. A squirrel-cage rotor according to the invention can be made in this manner.

According to a method variation, material of the carrier as well as also material of the squirrel-cage rotor conductor is removed. Furthermore, a casting can be configured such that the cage rings are cast jointly with a casting of the squirrel-cage rotor conductors.

### BRIEF DESCRIPTION OF THE DRAWING

Exemplary embodiments of the invention will now be described in greater detail by way of example, with reference to the figures, in which:

FIG. 1 shows a fragmentary cross section of a squirrel-cage rotor, and

FIG. 2 shows a cutaway of the cross section of FIG. 1.

### DETAILED DESCRIPTION OF PREFERRED EMBODIMENTS

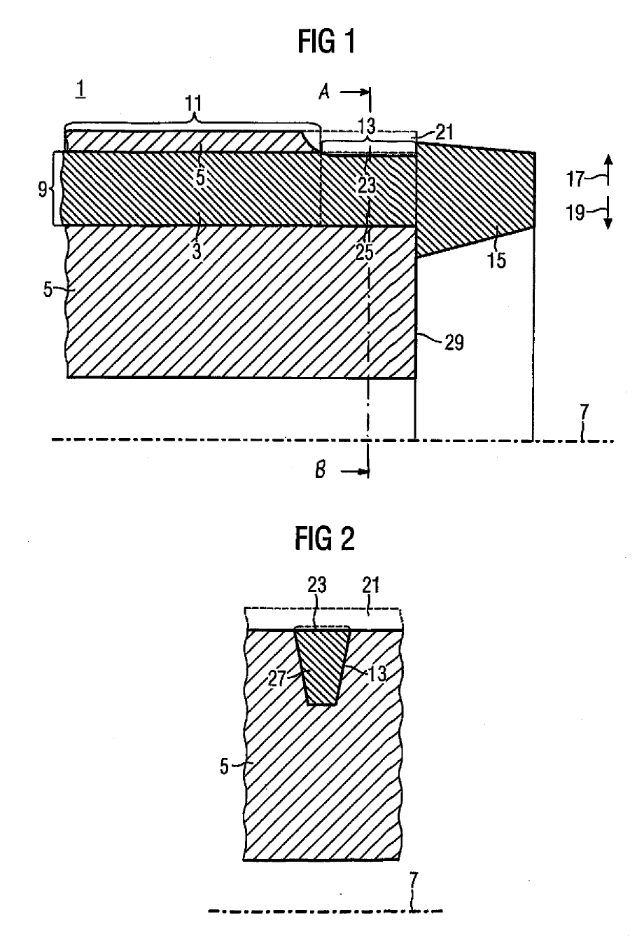

The illustration of FIG. 1 shows a portion of a cross section of a squirrel-cage rotor 1. The squirrel-cage rotor 1 has a squirrel-cage rotor axis 7. Arranged in surrounding relationship to the squirrel-cage rotor axis 7 is a rotatable carrier 5. The carrier 5 includes in particular magnetic material or is made of such a material. For example, the carrier 5 is a laminated core. The carrier 5 has slots 9 extending axially in relation to the rotation axis of the squirrel-cage rotor. The axial slots 9 are distributed especially rotation-symmetrical in the squirrel-cage rotor 1, i.e. in the carrier 5, wherein the rotation-symmetrical distribution is not shown in FIG. 1. The axial slots 9 can also be designed of beveled configuration.

The slot 9 includes different regions, i.e. portions. A region of the slot 9 is a closed slot portion 11 and another region is an open slot portion 13. A squirrel-cage rotor conductor 3 extends in the area of the closed slot portion 11. The squirrel-cage rotor conductor 3 is surrounded within the closed slot portion 11 e.g. all-round by the carrier 5. The squirrel-cage rotor conductor 3 is radially open outwardly in the area of the open slot portion 13 with respect to the squirrel-cage rotor axis 7. The squirrel-cage rotor conductor 3 is an aluminum rotor bar for example.

The illustrations of FIG. 1 and FIG. 2 depict an example of an arrangement of a rotor bar which has been optimized in the magnetically active rotor zone in accordance with electric aspects. The magnetically active rotor zone is in particular the area of the carder 5 which contains magnetic material. An example of a magnetic material includes a laminated core of soft-magnetic sheet metal.

In order to realize an open slot portion 13, material is removed from a closed slot in such a manner as to create an open slot portion 13. The illustration of FIG. 1 depicts hereby an area with stripped carrier material 21 and an area with stripped material 23 from the squirrel-cage rotor conductor. The squirrel-cage rotor conductors 3 end in the area of an end surface 29 of the squirrel-cage rotor 1. The squirrel-cage rotor conductors 3 are shorted there by means of a cage ring 15. The cage ring 15 is disposed hereby advantageously directly adjacent to the carrier 5.

The creation of the open slot portion 13 results in a flexible region of the squirrel-cage rotor conductor 3. When this squirrel-cage rotor conductor 3 is a rotor bar for example, a flexible conductor length of the rotor bar is established in the area of the open slot portion 13. When the squirrel-cage rotor conductor 3 and the cage ring 15, respectively, heats up and expands, an expansion is made possible in the area of the open slot portion 13 into a radially outer region 17. Expansion into a radially inner region 19 is prevented in view of the presence of the carrier 5 there. The possibility to expand radially outwards as the squirrel-cage rotor 1 and in particular the squirrel-cage rotor conductor 3, which advantageously are rotor bars, heat up, enables a reduction in material stress especially in the carrier 5 during operation. In particular the area of the cage ring 15 is subjected to high temperatures during operation so that the region of the open slot portion adjacent to the cage ring 15 reduces disadvantageous stress in an especially advantageous manner also of the cage ring 15 and the squirrel-cage rotor conductor 3, respectively, which are rotor bars in particular. FIG. 1 shows a section A, B.

The illustration according to FIG. 2 shows the section A, B of FIG. 1. Illustrated here is in particular the squirrel-cage rotor conductor 3 which is especially a bar conductor 27. As a consequence of the wedge-shaped configuration of the cross section of the bar conductor 27, the bar shape is optimized especially under mechanical considerations in the flexible zone of the open slot portion 13. The area of the squirrel-cage rotor conductor 3 in opposition to the open region of the open slot portion 13 includes the wider side of the wedge cross section. This is advantageous as more material results also in a greater expansion during heating.

1. A squirrel-cage rotor, comprising
squirrel-cage rotor conductors;
a cage ring for shorting the squirrel-cage rotor conductor, and
a carrier for support of the squirrel-cage rotor conductors, the carrier being provided with axial slots for accommodating the squirrel-cage rotor conductors, wherein at least one of the axial slots has at least one closed slot portion and an open slot portion, with the open slot portion located between the closed slot portion and the cage ring, and with the open slot portion having an opening which is located in a radially outer region of the at least one axial slot.

2. (canceled)

3. The squirrel-cage rotor claim 1 of claim 1, wherein the open slot portion has an opening which is located in a radially inner region of the at least one axial slot.

4. The squirrel-cage rotor of claim 1, wherein the at least one axial slot has a wedge-shaped cross section.

5. The squirrel-cage rotor of claim 1, wherein each of the squirrel-cage rotor conductors is a cast squirrel-cage rotor conductor.

6. The squirrel-cage rotor of claim 1, wherein each of the squirrel-cage rotor conductors is a bar conductor.

7. The squirrel-cage rotor of claim 1, wherein the carrier is disposed immediately adjacent to the cage ring.

8. The squirrel-cage rotor of claim 1, wherein the carrier includes soft-magnetic material.

9.-10. (canceled)

11. The method of claim 15, wherein the removing step includes the step of trimming away material of the squirrel-cage rotor conductors.

12. The method of claim 16, wherein the casting step includes the step of casting cage rings jointly with the the squirrel-cage rotor conductors.

13. (canceled)

14. The squirrel-cage rotor of claim 1, wherein the at least one axial slot has a parallel-shaped cross section.

15. A method of making a squirrel-cage rotor, comprising the steps of:
accommodating a squirrel-cage rotor conductor in a closed axial slot of a carrier; and
removing material from the carrier in the area of an end surface of the carrier to form an open slot portion with an opening which is located in a radially outer region of the axial slot.

16. The method of claim 15, wherein the accommodating step includes the step of casting the squirrel-cage rotor conductors in the closed slots of the carrier.

17. The method of claim 15, wherein the accommodating step includes the step of inserting the squirrel-cage rotor conductors in the form of bars in the closed slots of the carrier.

18. A method of making a squirrel-cage rotor, comprising the steps of:
accommodating a plurality of squirrel-cage rotor conductors in closed axial slots of a carrier;
shorting the squirrel-cage rotor conductors by a cage ring; and
removing material from the carrier in the area of an end surface of the carrier such as to provide at least one of the closed axial slots with an open slot portion with an opening which is located in a radially outer region of the axial slot.

19. The method of claim 18, wherein the squirrel-cage rotor conductors are each a bar conductor.

20. The method of claim 18, and further comprising the step of placing the carrier immediately adjacent to the cage ring.

21. The method of claim 18, and further comprising the step of making the carrier of soft-magnetic material.
